(19) United States
(12) Patent Application Publication
(10) Pub. No.: US 2022/0311768 A1
(43) Pub. Date: Sep. 29, 2022

(54) METHOD AND SYSTEM FOR DEFINING AND ENFORCING IP TRAFFIC POLICY FOR CONNECTED DEVICES

(71) Applicant: Aeris Communication, Inc., San Jose, CA (US)

(72) Inventors: Ethan Hoewisch, San Jose, CA (US); David Hu, Sunnyvale, CA (US); Dae Seong Kim, Campbell, CA (US); Narendra Sharma, Sunnyvale, CA (US); Drew S. Johnson, San Jose, CA (US); Maanasa Madiraju, Fremont, CA (US); Anitha Govindarajan, Elk Grove Village, IL (US)

(21) Appl. No.: 17/704,327

(22) Filed: Mar. 25, 2022

Related U.S. Application Data
(60) Provisional application No. 63/166,492, filed on Mar. 26, 2021.

(51) Int. Cl. H04L 9/40

(52) U.S. Cl. CPC H04L 63/0876; H04L 63/0263; H04L 63/0236; H04L 63/20

(57) ABSTRACT

A computer-implemented method, system, and computer program product for defining and enforcing network traffic policy for one or more devices enabled for connectivity over a communications network are disclosed. The method for defining and enforcing network traffic policy for one or more devices enabled for connectivity includes defining traffic policy rules for a service profile, wherein the service profile is service behavior definition based on communications network subscription; assigning a range of network assigned unique identifiers to the service profile; associating at least one device with at least one of the range of network assigned unique identifiers assigned to the service profile using communication network subscription identifier; and enforcing the defined traffic policy rules on the network traffic to and from the at least one device based on the network assigned unique identifier associated to the said at least one device.

### CROSS-REFERENCE TO RELATED APPLICATION

This application claims priority under 35 USC 119(e) to U.S. Provisional Application No. 63/166,492, filed Mar. 26, 2021, all of which is incorporated herein by reference in its entirety.

### FIELD OF THE INVENTION

The present invention relates generally to controlling traffic flow for connected devices using communications network.

### BACKGROUND

Connected devices, whether phones, radios, sensors or other types of hardware, for example, Machine to Machine (M2M) or Internet of Things (IoT) devices, that are intended to connect to communications networks, such as wireless or cellular networks, are enabled to connect to networks, such as by use with products such as Subscriber Identification Modules (SIMs). As IoT solutions are being deployed in high volume, the need and demand to define and enforce traffic policy for the traffic to and from such devices is becoming stronger. In most cases, this traffic policy is defined, implemented, and enforced at packet gateway. However, such implementation may not be always possible.

Accordingly, what are needed are system and method to address the above identified issues. The present invention addresses such a need.

### SUMMARY

A computer-implemented method, system and computer program product for defining and enforcing network traffic policy for one or more devices enabled for connectivity over communications network are disclosed. The method for defining and enforcing network traffic policy for one or more devices enabled for connectivity includes defining traffic policy rules for a service profile, wherein the service profile is service behavior definition based on communications network subscription; assigning a range of network assigned unique identifiers to the service profile; associating at least one device with at least one of the range of network assigned unique identifiers assigned to the service profile using communication network subscription identifier; and enforcing the defined traffic policy rules on the network traffic to and from the at least one device based on the network assigned unique identifier associated to the said at least one device.

In an embodiment, the system for defining and enforcing traffic policy for one or more devices enabled for connectivity over cellular network comprises one or more devices enabled for connectivity, a network assigned unique identifier management service (NAUIMS), a traffic control function (TCF) and a device provisioning service (DPS), wherein the device provisioning service (DPS) associates one or more devices to a service profile, and defines traffic policy rules for the service profile; the network assigned unique identifier management service (NAUIMS) assigns a range of network assigned unique identifiers to the service profile; and associates at least one device with one of the range of network assigned unique identifiers assigned to the service profile using communication network subscription identifier for the at least one device; and wherein the traffic control function (TCF) enforces the defined traffic policy rules on the network traffic to and from the at least one device based on the network assigned unique identifier assigned to the said at least one device.

In an embodiment, the computer program product stored on a non-transitory computer readable medium for defining and enforcing traffic policy for one or more devices enabled for connectivity over a communications network, comprising computer readable instructions for causing a computer to control an execution of an application for defining and enforcing traffic policy for one or more devices enabled for connectivity includes defining traffic policy rules for a service profile, wherein the service profile is service behavior definition based on communications network subscription; assigning a range of network assigned unique identifiers to the service profile; associating at least one device with at least one of the range of network assigned unique identifiers assigned to the service profile using communication network subscription identifier; and enforcing the defined traffic policy rules on the network traffic to and from the at least one device based on the network assigned unique identifier associated to the said at least one device.

In an embodiment, the communications network includes a cellular network, communications network subscription comprises a cellular subscription and network assigned unique identifiers comprise International Mobile Subscriber Identity (IMSI) for the at least one device.

In an embodiment, the network assigned unique identifier comprises an IP address and wherein the IP address is a static IP address or a dynamic IP address.

### BRIEF DESCRIPTION OF THE DRAWINGS

FIG. 1A illustrates an exemplary overview of process 100 for defining and enforcing traffic policy for one or more devices enabled for connectivity over communications network in accordance with an embodiment of the present invention.

FIG. 1B illustrates an exemplary overview of a system 100′ using process 100 for defining and enforcing traffic policy for one or more devices enabled for connectivity over communications network in accordance with an embodiment of the present invention.

FIG. 2A illustrates an exemplary overview of process 200 for defining and enforcing internet protocol (IP) traffic policy for one or more devices enabled for connectivity over cellular or wireless network in accordance with an embodiment of the present invention.

FIG. 2B illustrates an exemplary overview of system 200′ for defining and enforcing internet protocol (IP) traffic policy for one or more devices enabled for connectivity over cellular or wireless network in accordance with an embodiment of the present invention.

FIG. 2C illustrates an exemplary overview of system 200″ for defining and enforcing internet protocol (IP) traffic policy for one or more devices enabled for connectivity over cellular or wireless network in accordance with an embodiment of the present invention.

FIG. 2D illustrates an exemplary overview of system 200′″ for defining and enforcing internet protocol (IP) traffic policy for one or more devices enabled for connectivity over cellular or wireless network in accordance with an embodiment of the present invention.

FIG. 3 illustrates an exemplary overview of system 300 and process used for defining and enforcing internet protocol (IP) traffic policy for one or more devices enabled for connectivity over cellular or wireless network in accordance with an embodiment of the present invention.

FIG. 4 illustrates an exemplary overview of system 400 and process used for defining and enforcing internet protocol (IP) traffic policy for one or more devices enabled for connectivity over cellular or wireless network in accordance with an embodiment of the present invention.

FIG. 5 illustrates an exemplary overview of system 500 and process used for defining and enforcing Internet protocol (IP) traffic policy for one or more devices enabled for connectivity over cellular or wireless network in accordance with an embodiment of the present invention.

FIG. 6 illustrates an exemplary overview of system 600 and process used for defining and enforcing internet protocol (IP) traffic policy for one or more devices enabled for connectivity over cellular or wireless network in accordance with an embodiment of the present invention.

FIG. 7 illustrates an exemplary overview of system 700 and process used for defining and enforcing internet protocol (IP) traffic policy for one or more devices enabled for connectivity over cellular or wireless network in accordance with an embodiment of the present invention.

FIG. 8 illustrates an exemplary overview of system 800 and process used for defining and enforcing internet protocol (IP) traffic policy for one or more devices enabled for connectivity over cellular or wireless network in accordance with an embodiment of the present invention.

FIG. 9 illustrates an exemplary overview of system 900 and process used for defining and enforcing internet protocol (IP) traffic policy for one or more devices enabled for connectivity over cellular or wireless network in accordance with an embodiment of the present invention.

FIG. 10 illustrates an exemplary overview of system 1000 and process used for defining and enforcing internet protocol (IP) traffic policy for one or more devices enabled for connectivity over cellular or wireless network in accordance with an embodiment of the present invention.

FIG. 11 illustrates an exemplary overview of system 1100 and process used for defining and enforcing internet protocol (IP) traffic policy for one or more devices enabled for connectivity over cellular or wireless network in accordance with an embodiment of the present invention.

FIG. 12 illustrates an exemplary overview of system 1200 and process used for defining and enforcing internet protocol (IP) traffic policy for one or more devices enabled for connectivity over cellular or wireless network in accordance with an embodiment of the present invention.

FIG. 13 illustrates a data processing system 1300 suitable for storing the computer program product and/or executing program code relating to defining and enforcing internet protocol (IP) traffic policy for one or more devices enabled for connectivity over cellular or wireless network in accordance with one or more embodiments of the present invention.

### DETAILED DESCRIPTION

The present invention relates generally to controlling traffic flow for connected devices, for example, Machine to Machine (M2M), Internet of Things (IoT) devices, etc. using communications network connectivity.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Although the invention is described with respect to product such as a Subscriber Identification Module (SIM), as used herein the term “product” is intended to be inclusive, interchangeable, and/or synonymous with appliances, electronic modules, telephony equipment and other similar products that require registration of distinct identifying numbers, such as ICCIDs, IMSIs, MEIDs or other serial numbers as described further below and collectively referred to herein as “numbers”, for that product with a service provider to receive services, though one will recognize that functionally different types of products may have characteristics, functions and/or operations which may be specific to their individual capabilities and/or deployment. While the diagrams illustrated herein use IPv4 as examples, the solution would work as is or with minor tweaks for IPv6.

Devices, whether phones, radios, sensors or other types of hardware, known as Machine to Machine (M2M) or Internet of Things (IoT) devices, that are intended to connect to networks, such as wireless or cellular networks, are enabled to connect to networks, such as by use with products such as Subscriber Identification Modules (SIMs). As IoT solutions are being deployed in high volume, the need and demand to define and enforce traffic policy for the traffic to and from such devices is becoming stronger. In most cases, this traffic policy is defined, implemented and enforced at packet gateway. However, such implementation may not be always possible.

Accordingly, what are needed are system and method to address the above identified issues. The present invention addresses such a need.

A computer-implemented method, system and computer program product for defining and enforcing network traffic policy for one or more devices enabled for connectivity over communications network are disclosed. The method for defining and enforcing network traffic policy for one or more devices enabled for connectivity includes defining traffic policy rules for a service profile, wherein the service profile is service behavior definition based on communications network subscription; assigning a range of network assigned unique identifiers to the service profile; associating at least one device with at least one of the range of network assigned unique identifiers assigned to the service profile using communication network subscription identifier; and enforcing the defined traffic policy rules on the network traffic to and from the at least one device based on the network assigned unique identifier associated to the said at least one device.

In an embodiment, the system for defining and enforcing traffic policy for one or more devices enabled for connectivity over cellular network comprises one or more devices enabled for connectivity, a network assigned unique identifier management service (NAUIMS), a traffic control function (TCF) and a device provisioning service (DPS), wherein the device provisioning service (DPS) associates one or more devices to a service profile, and defines traffic policy rules for the service profile; the network assigned unique identifier management service (NAUIMS) assigns a range of network assigned unique identifiers to the service profile; and associates at least one device with one of the range of network assigned unique identifiers assigned to the service profile using communication network subscription identifier for the at least one device; and wherein the traffic control function (TCF) enforces the defined traffic policy rules on the network traffic to and from the at least one device based on the network assigned unique identifier assigned to the said at least one device.

In an embodiment, the computer program product stored on a non-transitory computer readable medium for defining and enforcing traffic policy for one or more devices enabled for connectivity over a communications network, comprising computer readable instructions for causing a computer to control an execution of an application for defining and enforcing traffic policy for one or more devices enabled for connectivity includes defining traffic policy rules for a service profile, wherein the service profile is service behavior definition based on communications network subscription; assigning a range of network assigned unique identifiers to the service profile; associating at least one device with at least one of the range of network assigned unique identifiers assigned to the service profile using communication network subscription identifier; and enforcing the defined traffic policy rules on the network traffic to and from the at least one device based on the network assigned unique identifier associated to the said at least one device.

In an embodiment, the communications network includes a cellular network, communications network subscription comprises a cellular subscription and communication network subscription identifier includes any of International Mobile Subscriber Identity (IMSI), MAC identifier and International Mobile Equipment Identity (IMEI) for the at least one device.

In an embodiment, the network assigned unique identifier comprises an IP address and wherein the IP address is a static IP address or a dynamic IP address.

Normally, IP addresses are assigned dynamically via a Packet Gateway. IP address assignment is one of several services normally done in the Packet Gateway and thus traffic policy is defined, implemented and enforced at packet gateway. Although such implementation may not be always possible, policies are required because they define what data traffic is allowed across the network. A policy says to either block or allow the packet to proceed.

The traffic control function, also referred to herein as Aeris Packet Function (APF), described herein, allows assignment of permanent or static or dynamic IP addresses to devices and to define and enforce a traffic policy at the packet level using those IP addresses. This allows customers to manage traffic policy across multiple MNO networks from a single interface.

The traffic control function works by associating a packet with a subscription through IMSI for the device because the subscription includes the traffic policy. Each packet has a source IP address and a destination IP address. For packets sent by a mobile device, the source IP address is the IP address of the mobile device, which may be permanent/static IP address or a dynamic IP address. For packets sent to a mobile device, the destination IP address is the IP address of the mobile device. A subscription is attached to a mobile device that includes an IMSI. For example, there are two identifiers for every mobile device subscription: the MSISDN (like your phone number, it is changeable) and the IMSI (this is an unchanging value). The method, system and computer program product described herein is based on assigning a permanent/static IP address or a dynamic IP address to the IMSI. The packets to and from the device use this static or dynamic IP address as the destination and source IP address, respectively, thereby allowing the traffic control function to enforce the traffic policy associated with the device at the packet level using the assigned IP address.

The method, system and computer program product described herein provide for mapping a permanent IP address of the device, also known as the source IP address to the IMSI for the device because, attached to the IMSI, is the subscription where the traffic policy is defined, and the traffic policy decides what to do with each packet coming from or going to that device. When using static IP, binding the IMSI to a static IP address on a persistent basis is also inventive/unique because the IMSI is part of a cellular network, and the IP address is part of the IP network. Assigning a permanent IP address to a mobile device enables the traffic control function to enforce the traffic policies defined at the cellular network at the IP network. The static IP address thus assigned may rarely change, for example, if the service profile for the device was changed or the device is decommissioned from service because the device is faulty.

By assigning a static IP address to the device a permanent association between the source IP address assigned to the mobile device and the IMSI is established. Once an IP address is associated with a particular IMSI, the system can look up the policy for that IMSI/device. Since a permanent or static IP address is assigned to the mobile device such that there is a permanent mapping, it is more efficient and practical, as no time is spent trying to map and re-map IP addresses to IMSIs in order to get to the policy every time the mobile device attaches to the network. This IP address assignment to a large number of devices cannot be achieved by a human. An application to handle the large volume of devices is required.

In an embodiment, when an association between the source IP address assigned to the mobile device and the IMSI may be established, the source IP address used may be permanent/static IP address or a dynamic IP address.

A customer can subscribe to multiple Access Point Names (APNs) if they want to keep the same IP address across multiple APNs, but most likely will have different IP addresses on different APNs. In an example, the NAUIMS may Assign IP Address 1.2.3.4 with APN 1 to Customer 1 and assign IP Address 1.2.3.4 with APN 2 to Customer 2, thus assigning the same IP address to different customers. IMSI is the unique handle for the identifier and the static IP assigned to the IMSI provides an ultimate handle to provide access to the device. This may benefit the customer because customer does not have to know which APN they are connected to or do not need to keep track of multiple end points. This use case is possible but not what would happen naturally. Alternatively, customer can request/reserve the same static IP address on different APNs.

In another example, different APNs provide different services to the customer. For example, a first APN provides access to the internet, and a second APN could be used for a company's private network. Using the same IP address on different APNs makes it easier for the customer to switch APNs.

Additionally, to reduce the number of traffic rules, all devices that share the same traffic rule may be assigned into the same network segment or subnet. This may be accomplished by performing IP allocation from the APNs with blocks, network segments or subnets. A sequential/contiguous block of IP addresses may be defined as a network segment or a subnet. If rules were enforced at an individual IP address level, then each device would need one rule in the traffic control function. This would make a large volume of rules to keep track of. However, if the devices that share traffic rules are assigned IP addresses within a contiguous IP address range (same network segment or subnet), then the same rule can be applied to every device with IP addresses between the beginning and the end of the IP address range resulting in one set of rules to be applied to the network segment or subnet (range of addresses).

When a service profile is created, a block of contiguous IP addresses is pre-allocated to use with that service profile. As the devices are provisioned against that service profile, the IP addresses for those devices come out of the same block of IP addresses, thus requiring only one rule or a single set of rules in the traffic control function, for example, APF, for all of those devices. The service profile defines these blocks of IP addresses for each APN. One of the attributes of the service profile is the APN to be used. There may be more than one APN associated with that service profile. When the service profile is created, for each APN defined that can be used. blocks of IP addresses are allocated. This is an example of a way that a device allowed to access two different APNs (because the device's service profile has more than one APN associated with it) could end up with two different IP addresses.

When a device is provisioned, one IP address is taken out of each APN(s) associated with the service profile. If a service profile is associated with 2 APNs, then the device gets an IP Address from each of the 2 APNs. The Service Profile defines the device behavior, such as whether packet data or voice or SMS are enabled, and a list of APNs that devices associated with the Service Profile can use. Based on the profile, the rules are assigned, network segments or subnets of IP addresses are assigned to the service profile, and a block of IP addresses are assigned per service profile.

The traffic control function is able to associate IP address in the packets to IP pool which in turn is associated with the service profiles, and service profiles to accounts. This enables the traffic control function to enforce traffic rules that apply to all devices on a customer's account, for example, allowing the devices of a customer's account to access network resources dedicated to that customer. This also allows the traffic control function to implement quality of service rules.

The traffic control function is also able to capture traffic to or from a designated device, even if that device de-registers and re-registers with the cellular network. This is similar to the port mirroring feature of network switches, and would allow customer to watch the packet flow for a customer's device.

In an embodiment, when an association between the source IP address assigned to the mobile device and the IMSI may be established, the source IP address used may be permanent/static IP address or a dynamic IP address. It is possible to assign a network-assigned unique identifier when a device attaches to the network (using dynamic IP address), instead of when a device is provisioned (using static IP address).

For example, in step 1, a customer makes a request to provision a device with for example, IMSI 123456789012345 is against Service Profile 987. In step 2, the Connectivity Management Portal collaborates, directly or indirectly, with: a. the Device Provisioning Service to ensure that the Provisioning Database has a record of the device's association to the Service Profile; b. the NAUIMS to ensure the Provisioning Database's record for the Service Profile has a sufficiently-sized pool of IP addresses; and c. the APF Manager to ensure that the APF is aware of the association of Service Profile to pool of IP addresses.

During step 3, the device with IMSI 123456789012345 joins the cellular network and establishes a data session. This causes the P-GW to send an Access-Request to an Authentication, Authorization and Accounting (AAA) server. The AAA looks up the pool of IP addresses for the device and selects an IP address for the device, for example, a. by randomly choosing an IP address from the pool; b. the AAA replies to the Access-Request with the dynamically chosen IP address. During step 4, packets sent to and from the device will now traverse the Core Network via the APF.

Advantages of this attach-time assignment of IP address to device include, but are not limited to: preservation of the mapping of network-assigned unique identifier to service profile, and service profile to set of traffic rules/traffic policies for that service profile; ability to assign multiple IP addresses to a device. For example, if a customer requirement is to assign multiple IP addresses to a single device in same APN, also referred to as Multiple IPs Per-Device. It also allows provisioning more devices than there are IP addresses available for a given VLAN/VXLAN/tunnel, assuming that not all devices associated with a service profile need to establish data sessions at the same time.

Similar to assigning static IP addresses, dynamic IP addresses may be assigned to the devices, where the dynamic IP addresses may be picked from a block of IP addresses assigned to a service profile and the traffic control function is able to associate packets to service profiles, and service profiles to accounts. This enables the traffic control function to enforce traffic rules that apply to all devices on a customer's account, for example, allowing the devices of a customer's account to access network resources dedicated to that customer. This also allows the traffic control function to implement quality of service rules.

When static or dynamic IP addresses are assigned to devices, the traffic control function is also able to capture traffic to or from a designated device, even if that device de-registers and re-registers with the cellular network. This is similar to the port mirroring feature of network switches, and would allow customer to watch the packet flow for a customer's device.

The embodiments described herein allow the traffic policies to be defined and enforced at customer level and/or for groups of devices for a customer based on service profiles and IP pool assignments to the service profiles or per device level. The traffic policy definition and enforcement may be network agnostic, location specific and scalable for large number of IoT devices.

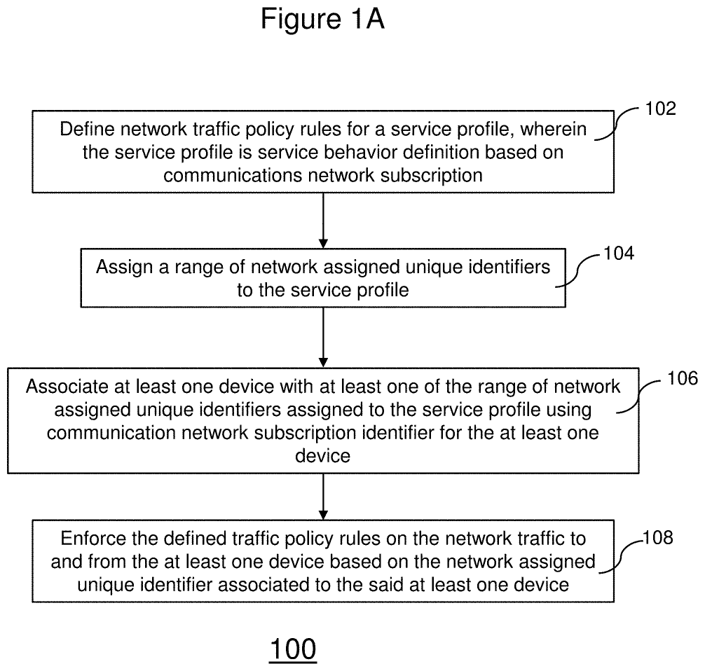

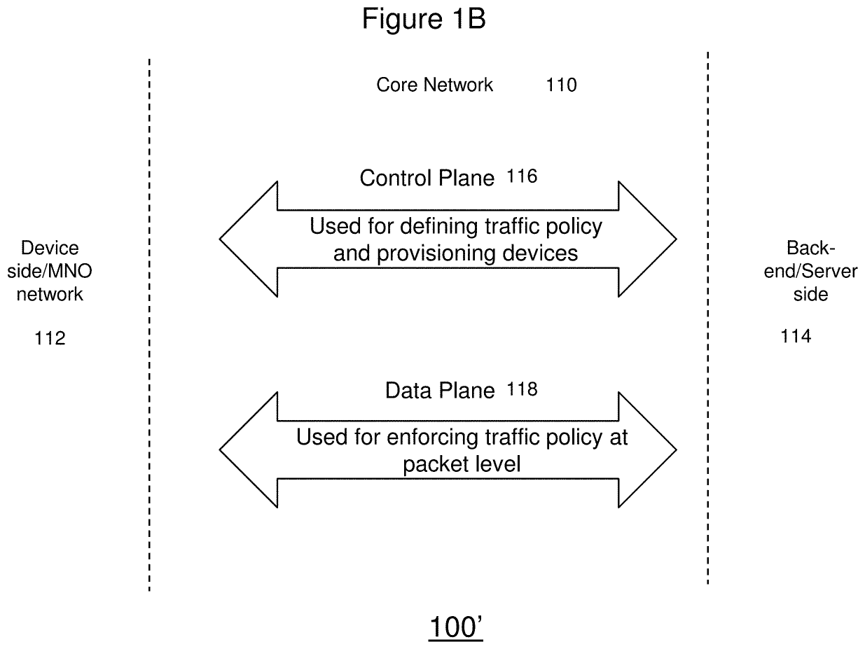

FIG. 1A illustrates an exemplary overview of process 100 for defining and enforcing traffic policy for one or more devices enabled for connectivity over communications network in accordance with an embodiment of the present invention. For example, a method for defining and enforcing network traffic policy for one or more devices enabled for connectivity includes defining traffic policy rules for a service profile via step 102, wherein the service profile is service behavior definition based on communications network subscription; assigning a range of network assigned unique identifiers to the service profile via step 104; associating at least one device with at least one of the range of network assigned unique identifiers assigned to the service profile using communication network subscription identifier via step 106; and enforcing the defined traffic policy rules on the network traffic to and from the at least one device based on the network assigned unique identifier associated to the said at least one device via step 108.

FIG. 1B illustrates an exemplary overview of a system 100′ using process 100 for defining and enforcing traffic policy for one or more devices enabled for connectivity over communications network in accordance with an embodiment of the present invention. In an embodiment, the system for defining and enforcing traffic policy for one or more devices enabled for connectivity over cellular network comprises one or more devices enabled for connectivity, a network assigned unique identifier management service (NAUIMS), for example, IP management system (IPMS), a traffic control function (TCF), for example, Aeris Packet Function (APF), and a device provisioning service (DPS), wherein the network assigned unique identifier management service (NAUIMS) assigns a range of network assigned unique identifiers to a service profile; associates at least one device with one of the range of network assigned unique identifiers assigned to the service profile using communication network subscription identifier for the at least one device; and defines traffic policy rules for the service profile. The traffic control function (TCF) enforces the defined traffic policy rules on the network traffic to and from the at least one device based on the network assigned unique identifier assigned to the said at least one device.

As illustrated in FIG. 1B, defining traffic policy rules for a service profile via step 102, wherein the service profile is service behavior definition based on communications network subscription; assigning a range of network assigned unique identifiers to the service profile; associating at least one device with at least one of the range of network assigned unique identifiers assigned to the service profile using communication network subscription identifier; and provisioning the one or more devices takes place in a control plane 116 of the mobile virtual network operator's or mobile network operator's core network 110, whereas enforcing the defined traffic policy rules on the network traffic to and from the at least one device based on the network assigned unique identifier assigned to the said at least one device takes place in a data plane 118 of the mobile virtual network operator's core network 110.

APF Manager stores and distributes traffic policies to APF packet processors via control plane 116. In an embodiment, the APF manager may be provided with region specific traffic policies based on location of the devices, which are distributed by APF manager via control plane 116, illustrated as MANO, to APF packet processors, as applicable and are enforced by the APF packet processors via data plane 118. Global IoT programs like connected car or electric vehicle (EV) charging system may benefit from single SKU of eSIM to optimize the cost and supply chain management. Global IoT programs may have to deal with regional data sovereignty rules and regulations that require them to use local MNOs and run instances of their cloud services in respective regions or countries. Further, the eSIM may be provided with multiple profiles from different MNOs with different rate plans. Managing traffic policies for such global IoT programs deployed on combination of networks and regions, optimizing cost and applying consistent security policies, can be challenging.

In such cases, the traffic control policies for APF, can be deployed in different regions, clouds and data centers via traffic control function, for example, APF, control plane 116 to enforce regional traffic policies specific to a particular region or a particular MNO or both. The traffic control function, for example, APF, control plane 116 may smartly distribute policies to appropriate traffic control function, for example, APF, data plane 118, which then enforces those policies.

Since traffic control function, for example, APF, operates at IP level, it can manage and enforce policies for networks, device and services that natively receive or transmit IP traffic, or that can use IP as overlay to receive or transmit non-IP traffic. Thus, in an embodiment, the traffic policy rules defined for a service profile may further include rules specific to a specific region or a geographical location.

In an embodiment, the communications network includes a cellular network, communications network subscription comprises a cellular subscription and network assigned unique identifiers comprise International Mobile Subscriber Identity (IMSI) for the at least one device. In an embodiment, the network assigned unique identifier comprises an IP address.

Although the following description is provided using cellular network and internet protocol (IP) traffic, where the traffic policy is enforced at IP level based on subscription rules defined at network connectivity level/cellular level, other networks and network assigned unique identifiers other than internet protocol (IP) addresses may be used.

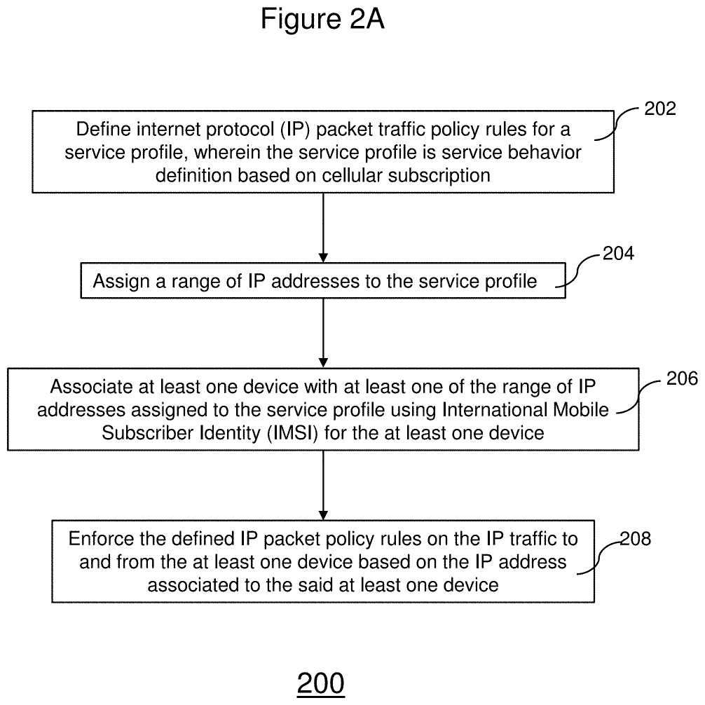

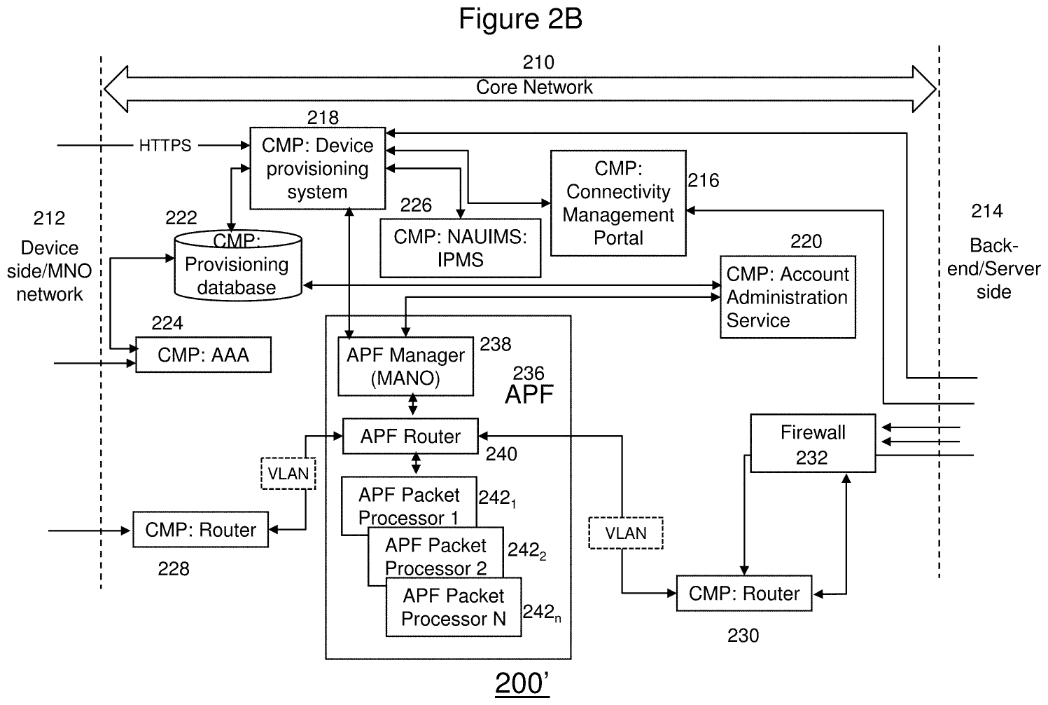

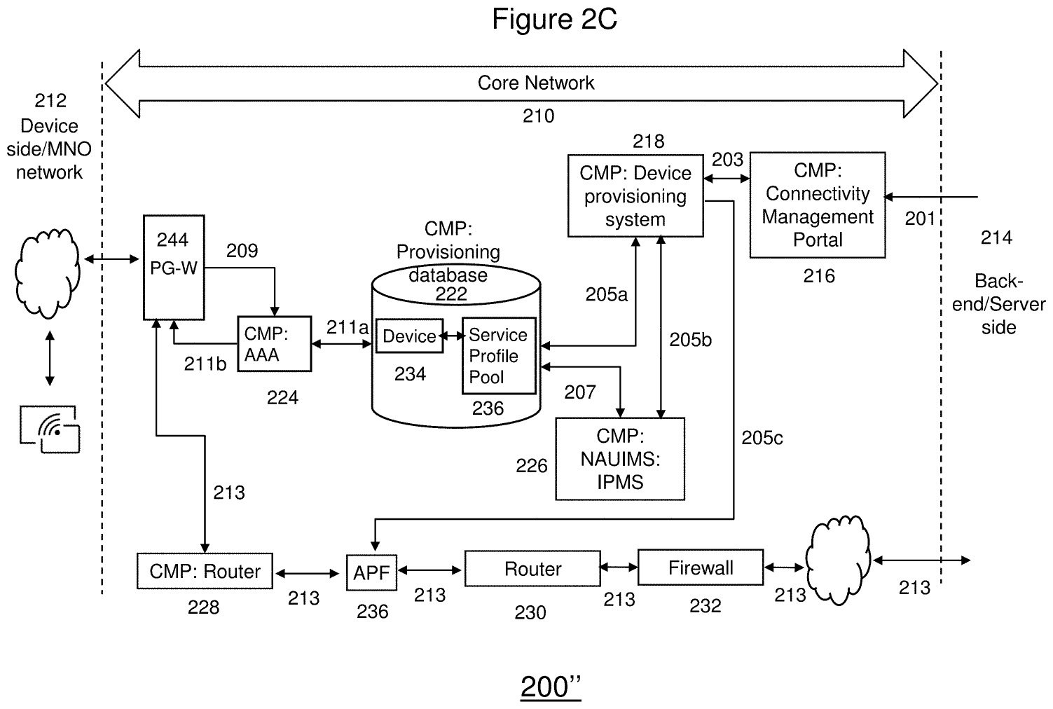

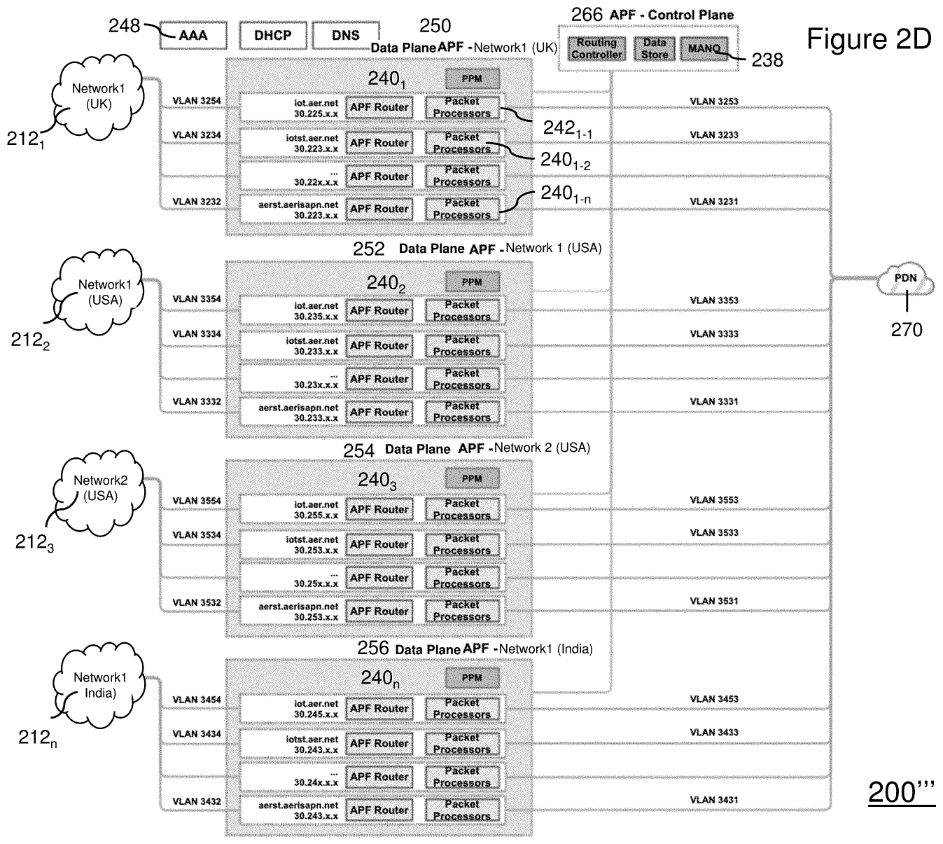

FIG. 2A illustrates an exemplary overview of process 200 using systems 200′, 200″ and 200′″ illustrated in FIGS. 2B, 2C and 2D for defining and enforcing traffic policy for one or more devices enabled for connectivity over cellular or wireless network in accordance with an embodiment of the present invention. In an embodiment, the traffic control function illustrated as APF essentially allows, blocks, or logs the packet passing through the traffic control function. As illustrated in FIG. 2B, a permanent/persistent static IP address, or as illustrated in FIG. 2C, a dynamic IP address is assigned/associated to a mobile subscription/device. The device has a SIM and a radio module in it, but without a subscription with a carrier, these would be of no use. Once the mobile subscription is associated with the SIM, the device containing the SIM can connect to a communications network. As part of this connection, the network operator's Packet Gateway may assign the device an IP address via step 204. The choice of IP address depends on the network operator's policies and network setup. For example, the Packet Gateway may assign IP addresses to devices on an APN from the entire 10.0.0.0/8 space; the Packet Gateway may allow an unlimited number of APNs to enable a large number of devices. (Note: “10.0.0.0/8” refers to an IP block ranging from “10.0.0.0” to “10.255.255.255”, or 16.7 million IP addresses. In the example above, the Packet Gateway would be able to support 16.7 million IP addresses per APN.)

An IP packet policy rules associated via step 206 with the mobile subscription is defined via step 202. A policy is a set of rules for individual subscriptions or groups of subscriptions (defined in service profiles) that define how we want the device to behave. In the IoT area, defining policy in the service profile is more common and useful. To do so, policies are defined at a service profile level related to whether the traffic is allowed or not via step 202. Thus, the traffic policy rules may be defined as a set of rules for individual subscriptions or one or more groups of subscriptions that define device behavior.

The defined IP packet policy rules are enforced on the IP traffic to and from the mobile device using its mobile subscription via step 208. Once the policy is defined and associated with the subscription/IMSI, the traffic control function, for example, Aeris Packet Function (APF), looks at the source or destination IP address in each packet going through the traffic control function, and from the source or destination IP address and direction of the packet, knows the IMSI, and then looks up the policy to see if it should allow the packet to go through. For example, the traffic control function would examine the source IP address, which may be permanent or static IP address or a dynamic IP address, of a packet sent from a device to determine what traffic rule to enforce.

The simple use case for allowing or not allowing IP packet traffic is based on destination IP address. If the destination IP address is not in an allow list, then drop the packet. This prevents someone from putting the SIM in another device and using it for another purpose, such as communicating with hosts not explicitly allowed by the allow list. This type of deny-listing/allow-listing based on destination IP address is described in a co-pending and co-owned U.S. patent application Ser. No. 16/879,087 entitled “TRAFFIC FLOW CONTROL USING DOMAIN NAME”. This may also prevent someone to be able to remove a SIM from an IoT device that has a subscription associated with it and put that SIM in some other device, such as a tablet, and using that tablet to search the internet or use cellular data in other ways when the subscription was paid for and intended to be used only for the IoT device. This nefarious use may be prevented by specifying that this subscription allows the data to go to a specific backend server's IP address, and any attempt to send it elsewhere will fail. For example, for a particular IMSI, packet data from the mobile device with that IMSI is blocked when the data is being sent to a destination address other than the allow-listed destination IP address.

Another use case of enforcement may include defining a class of service in the policy. For example, 1st class allows all packets to go through, 2nd class allows only 80% of packets to go through, and so on, also known as traffic shaping based on priority. Although both cases described above may result in blocking or allowing the data packets to travel across the network, a person skilled in the art may readily recognize that there may be many other ways to define how and why traffic could be allowed.

In an embodiment, with millions of IoT devices, service profiles may be established to define traffic policies. A service profile defines basic device behaviors and services allowed for individual device and/or for a group of IoT/M2M devices. It may define how the device should behave, is SMS allowed, is voice allowed, is packet data allowed, which APN should it use, etc. An owner of multitudes of devices can define one or more service profiles for their devices. In an embodiment, these policies may be defined at a service profile level, which is more efficient than defining a policy for each individual device. For example, define a policy in a service profile that specifies that the destination IP address for packets coming from devices mounted to irrigation lines must point to the server of the farmer who owns the irrigation lines, or define a policy in a service profile that says that packets coming from devices with that service profile are only allowed to go through between 8 am and 5 pm daily, etc.

The method, system and computer program product described herein uses binding an IP address to a device subscription at the time of provisioning. This is accomplished by associating the IP address with an IMSI. Every subscription has an IP traffic-related policy. This IP traffic-related policy is also known as a set of policy and charging control rules (FCC), which includes bandwidth control, gating control (which hosts are allowed), and priority control (some subscriptions have higher priority over others in case of high traffic, lower priority items are transmitted secondarily). The IP address is static and remains with the device indefinitely or until an event such as decommissioning the device happens. IMSI belongs to the carrier.

FIGS. 2B, 2C and 2D illustrate exemplary overview of systems 200′, 200″ and 200′″ for defining and enforcing traffic policy for one or more devices enabled for connectivity over cellular or wireless network in accordance with an embodiment of the present invention. For example, in an embodiment, the system 100′ may include mobile virtual network operator (MVNO) core network 210 which is used for defining and enforcing traffic policy on the traffic to and from the devices. The MVNO core network includes connectivity management platform (CMP): account administration service 220; device provisioning service (DPS) 218, also known as device registration service (DRS); connectivity management portal 216; one or more routers 228 and 230; one or more storage databases, for example, a provisioning database 222; an authentication, authorization, and accounting server (AAA) 224; NAUIMS illustrated herein as an IP management system (IPMS) 226; and a traffic control function (TCF), illustrated as Aeris Packet Function (APF) 236.

Although various embodiments described herein are described using or mobile virtual network operator (MVNO) core network, mobile network operator (MNO) core network or other types of core networks may also be used.

For example, the IPMS described herein may be equivalent to the NAUIMS described in the description accompanying FIG. 1B and the MVNO core network described herein may be, for example, an IP core network or a LoRa network.

FIG. 2B illustrates an exemplary embodiment for associating static IP address with a unique identifier. The mobile virtual network operator (MVNO) core network may interact with a client, for example, a client orchestration service. The client orchestration service may include client packet gateway (PGW) which sends request for authentication and internet protocol (IP) address for one or more devices during cellular registration of the one or more devices to AAA server. The traffic control function (TCF), for example, APF, 236 is configured during account or service profile creation performed by, for example, account administration service 220 of connectivity management platform and device provisioning performed by, for example, device provisioning service (DPS) 218. IP addresses are allocated to the one or more devices during device provisioning and also includes updates to the traffic control function's (TCF) management and orchestration module, illustrated as APF manager 238.

The device provisioning service (DPS) 218 associates one or more devices to a service profile, and defines traffic policy rules for the service profile. The network assigned unique identifier management service (NAUIMS) 226 assigns a range of network assigned unique identifiers to the service profile; and associates at least one device with one of the range of network assigned unique identifiers assigned to the service profile using communication network subscription identifier for the at least one device. The traffic control function (TCF) 236 enforces the defined traffic policy rules on the network traffic to and from the at least one device based on the network assigned unique identifier assigned to the said at least one device.

The traffic control function is also able to capture traffic to or from a designated device, even if that device de-registers and re-registers with the cellular network. This is similar to the port mirroring feature of network switches, and would allow customer to watch the packet flow for that customer's device.

In an embodiment, when an association between the source IP address assigned to the mobile device and the IMSI may be established, the source IP address used may be permanent/static IP address or a dynamic IP address. It is possible to assign a network-assigned unique identifier when a device attaches to the network, for example, dynamic IP address, instead of when a device is provisioned, for example, static IP address.

FIG. 2C illustrates an exemplary embodiment for associating a unique identifier with dynamic IP address, also known as attach time assignment of IP address. For example, in step 201, a customer makes a request to provision a device with, for example, IMSI 123456789012345 is against Service Profile 987. In step 203, the Connectivity Management Portal (CMP) 216 collaborates, directly or indirectly, with the Device Provisioning Service (DPS) 218 to ensure that the Provisioning Database 222 has a record of the association of device 234 to Service Profile 236 via step 205a; the NAUIMS 226 to ensure the Provisioning Database's 222 record for the Service Profile has a sufficiently-sized pool of IP addresses via step 205b and step 207; and the APF Manager to ensure that the APF 236 is aware of the association of Service Profile to pool of IP addresses via step 205c. Although the APF manager is not shown here the APF 236 illustrated here includes components such as APF manager, APF router and APF packet processors similar to the APF 236 illustrated in FIG. 2B.

During step 209, the device with IMSI 123456789012345 joins the cellular network and establishes a data session. This causes the P-GW 244 to send an Access-Request to the AAA 224. The AAA 224 looks up the pool of IP addresses for the device in the device provisioning database 222 and selects an IP address for the device, for example, a. by randomly choosing an IP address from the pool via step 211a; the AAA 224 replies to the Access-Request with the dynamically chosen IP address via step 211b. During step 213, packets sent to and from the device will now traverse the Core Network 210 via the APF 236.

Advantages of this attach-time assignment of IP address, also referred to herein in as dynamic IP address assignment to device include, but are not limited to: preservation of the mapping of network-assigned unique identifier to service profile, and service profile to set of traffic rules/traffic policies for that service profile; ability to assign multiple IP addresses to a device. For example, if a customer requirement is to assign multiple IP addresses to a single device in same APN, also referred to as Multiple IPs Per-Device. It also allows provisioning more devices than there are IP addresses available for a given VLAN/VXLAN/tunnel, assuming that not all devices associated with a service profile need to establish data sessions at the same time.

Similar to assigning static IP addresses, dynamic IP addresses may be assigned to the devices, where the dynamic IP addresses may be picked from a block of IP addresses assigned to a service profile and the traffic control function is able to associate packets to service profiles, and service profiles to accounts. This enables the traffic control function to enforce traffic rules that apply to all devices on a customer's account, for example, allowing the devices of a customer's account to access network resources dedicated to that customer. This also allows the traffic control function to implement quality of service rules.

When static or dynamic IP addresses are assigned to devices, the traffic control function is also able to capture traffic to or from a designated device, even if that device de-registers and re-registers with the cellular network. This is similar to the port mirroring feature of network switches, and would allow customer to watch the packet flow for a customer's device.

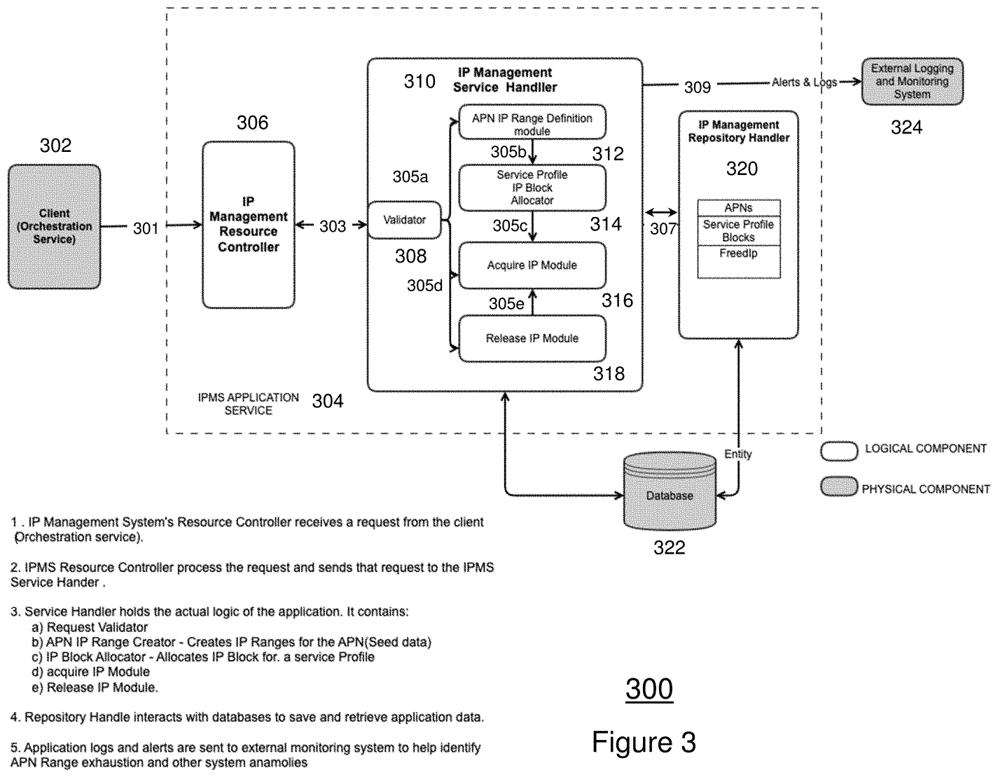

The IP management system (IPMS) illustrated in FIGS. 2B and 2C and described herein may include IP management system (IPMS) resource controller, IP management system (IPMS) service handler, IP management system (IPMS) repository handler which holds the definition for 3 entities, namely, APN, Service Profile Block and Freed IP, and a storage database. The IP management system (IPMS) service handler may further include a validator, APN IP range definition module, service profile IP block allocator, acquire IP module and release IP module. Although these are illustrated separately in FIG. 3, they may be a part of one processing module (a processor) as logical components or different processing modules.

The traffic control function (TCF), illustrated as Aeris Packet Function (APF) 236, in FIGS. 2B, 2C and 2D and described herein may include APF Manager 238, APF Router 240, and one or more APF Packet Processors 242₁, 242₂, . . . 242ₙ. The traffic control function (TCF), illustrated as Aeris Packet Function (APF) 236 in FIGS. 2B, 2C and 2D and described herein operates in the IP network and operates on individual IP packets sent from and to one or more devices. It can perform various operations on a data packet, for example, allow the packet to proceed to its destination, block the packet, log flow information about the packet (source IP, destination IP, packet size), or redirect the packet (change the destination). From these primitives interesting use cases may be implemented such as Connection Lock (only allow access to a defined set of IP addresses), security policies (such as forbidding traffic from one customer's devices from reaching another customer's devices), and traffic shaping policies including quality of service (QoS), delay control, throttle and prioritization based on protocol, destination etc., application specific use cases for packet rewrite, etc.

APF Manager 238 stores and distributes traffic policies to APF packet processors. In an embodiment, as illustrated in FIG. 2C, the APF manager may be provided with region specific traffic policies based on location of the devices, which are distributed by APF manager, illustrated as MANO, 238 to APF packet processors, as applicable. Global IoT programs like connected car or electric vehicle (EV) charging system may benefit from single SKU of eSIM to optimize the cost and supply chain management. Global IoT programs may have to deal with regional data sovereignty rules and regulations that require them to use local MNOs and run instances of their cloud services in respective regions or countries. Further, the eSIM may be provided with multiple profiles from different MNOs with different rate plans. Managing traffic policies for such global IoT programs deployed on combination of networks and regions, optimizing cost and applying consistent security policies, can be challenging.

In such cases, the APF data plane can be deployed in a distributed environment like different cloud, region and data center. The traffic control policies for APF are distributed by APF control function manager to the APF data plane nodes based on APF data plane region(s) it is deployed in and the network(s) it is integrated with. The traffic control function, for example, APF manager 238, via control plane 266, may smartly distribute policies to appropriate traffic control function, for example, APF, data plane, for example 250, 252, 254 and 256 illustrated in FIG. 2D for example, for Network 1 (UK), Network 1 (USA), Network 2 (USA), Network 1 (India) etc.

Since traffic control function, for example, APF, operates at IP level, it can manage and enforce policies for networks, device and services that natively receive or transmit IP traffic, or that can use IP as overlay to receive or transmit non-IP traffic. Thus, in an embodiment, the traffic policy rules defined for a service profile may further include rules specific to a specific region or a geographical location.

For example, as the traffic to or from the device passes through the APF router 240, it is routed through one or more packet processors, illustrated as packet processor 1 242₁, packet processor 2 242₂, . . . packet processor N 242_{N}, etc. The traffic policy rules distributed by APF manager 238 are loaded into the packet processors 242₁, 242₂, . . . 242_{N} and data traffic is routed through the packet processors 242₁, 242₂, . . . 242_{N} based on the direction of the packet, its source or destination IP address, and the service profile associated with that source or destination IP address. The packet processors 242₁, 242₂, . . . 242_{N} process the traffic based on rules, for example, to allow or block and log the incoming and outgoing traffic.

The traffic control function (TCF), illustrated as Aeris Packet Function (APF) 236, in FIGS. 2B, 2C and 2D and described herein achieves enforcement of traffic policies by storing service profile information in a storage database. This service profile information includes which blocks of device IP addresses have been assigned to the service profile by the IPMS, also referred to herein as NAUIMS 226, and the traffic rule assigned to the service profile. This service profile information is disseminated to APF Router(s) 240 or APF Packet Processors 242₁, 242₂, . . . 242_{N} so that the APF Router(s) 240 can route packets of devices belonging to a certain service profile to an APF Packet Processor assigned the traffic rule, and, because the APF Packet Processor knows the mapping of device IP addresses to service profile, and the mapping of service profile to traffic rule, the APF Packet Processor can apply the traffic rule against the packets of the devices of the service profile. The APF Packet Processor can implement the traffic rule using, for example, a Linux kernel level IP filtering package. The APF Packet Processor may implement, for example, one of the traffic policies such as filtering IP based on different attributes, also known as IP filter, which may use different attributes such as source IP, destination IP, source port, source protocol, destination port, destination protocol, or any other content or fields of the IP packets for the filtering process. The IP filter may also redirect the packet (layer2, layer3, or any layer) based on these attributes from one destination address to another. This new destination is then used in the IP network to route all the traffic through it and for applying traffic rules to the traffic routed through it.

However, the implementation of this workflow may present further complexity given that there may be millions of devices. If every device is given an IP address, the number of devices may be limited to the 16.7M IP addresses in the 10.0.0.0/8 CIDR block because there are only 16.7M IP addresses in the 10.0.0.0/8 private addresses CIDR bock commonly used for private networks. To allow a lot more than 16.7M devices on the network, a full 10.0.0.0/8 address space may be assigned to each APN. An APN (like iot.aer.net) is like a normal Internet hostname, but it defines a full set of behaviors on the P-GW, including how to handle IP traffic. Further complexity may arise if the MVNO has multiple APNs, which may create overlapping IP addresses for devices using different APNs.

In an embodiment, this complexity in implementation may be resolved by using VLANs to isolate traffic. VLANs are supported by a standard called 802.1Q where each low-level layer 2 network packet is tagged with an extra number identifying its VLAN. Modern network equipment uses this extra tag to keep IP network traffic separated as if it were on separate network cables, even though they are actually all on a single cable. Therefore, in an embodiment, part of the job of the APF and the MVNO IP network is to keep a mapping of APNs to VLAN IDs. The traffic control function (TCF) (APF) can then use this to be able to find the correct VLAN where a particular cellular device's IP traffic is found. Although VLAN is used as an example here, other technologies such as but not limited to VXLAN, other overlay or tunneling technologies may be used and are also within the scope of this invention.

FIG. 3 illustrates an exemplary overview of system 300 and process used for defining and enforcing traffic policy for one or more devices enabled for connectivity over cellular or wireless network in accordance with an embodiment of the present invention. In an embodiment, the system 300 includes a client orchestration service 302, IP management system (IPMS) resource controller 306, IP management system (IPMS) service handler 310, IP management system (IPMS) repository handler 320 which holds the definition for 3 entities, namely, APN, Service Profile Block and Freed IP, and a storage database 322. The IP management system (IPMS) service handler may further include a validator 308, APN IP range definition module 312, service profile IP block allocator 314, acquire IP module 316 and release IP module 318. Although these are illustrated separately in FIG. 3, they may be a part of one processing module (a processor) as logical components or different processing modules.

In an embodiment, the IP management system (IPMS) resource controller receives a request from the client orchestration service to acquire IP via step 301. IP management system (IPMS) resource controller processes the request and sends it to the IP management system (IPMS) service handler via step 303.

The IPMS service handler 310 holds the actual logic of the application including request validator 308 via step 305a, which determines if the received request is a valid request, APN IP range creator or IP range definition module 312, which creates IP address ranges for a particular APN, service profile IP block allocator 314, which allocates one or more IP address blocks to a service profile along with acquire IP module and release IP module. The IP allocation process includes defining IP address ranges for the APN(s) and defining service profiles via step 305b, which may also be known as creating seed data: acquiring IP address which includes IP address block allocation and device association via step 305c; and releasing (freeing up) IP addresses to enable re-use of IP addresses via step 305d, which may be acquired for use via step 305d and 305e by Acquire IP module 316.

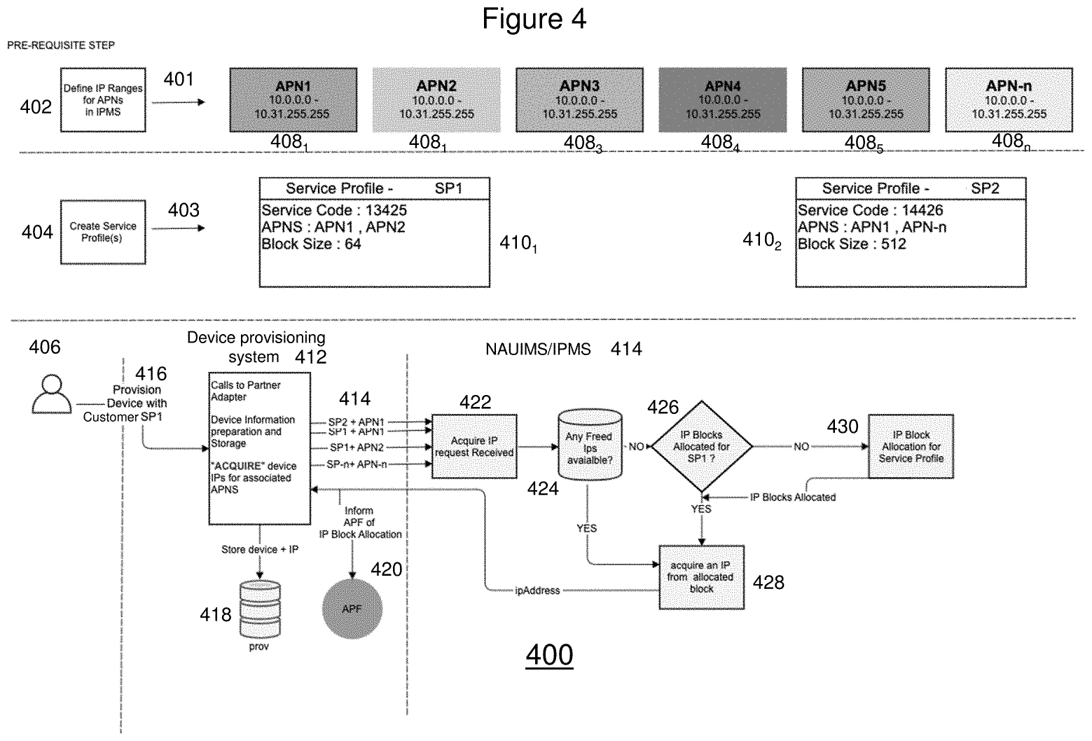

IPMS repository handler 320 interacts with one or more databases to save and retrieve application data via step 307. The application logs and alerts may be saved and/or sent to an external monitoring system 324 via step 309 to help identify APN range exhaustion and/or other system anomalies. The process of interacting with one or more databases is illustrated in FIG. 4 and described in detail in the description accompanying FIG. 4.

FIG. 4 illustrates an exemplary overview of system 400 and process performed by the IPMS service handler used for defining and enforcing traffic policy for one or more devices enabled for connectivity over cellular or wireless network in accordance with an embodiment of the present invention. In an embodiment, the IP allocation process, step 402, includes defining IP ranges for APN(s) via step 401 by APN IP range definition module which is equivalent to creating big IP pool buckets for APNs 408₁, 408₂, . . . 408ₙ IP block allocation by service profile IP block allocator which is equivalent to creating small IP pool buckets for each service profile+APN, but fetching few sequential IP addresses from the big APN Bucket and device association which is equivalent to taking one IP per device from the small buckets created in the earlier step, acquiring IP addresses by acquire IP module and releasing freed up IP addresses by release IP module.

The process further includes creating one or more service profiles, for example, 410₁, 410₂ etc. via step 404. IoT customer onboarding process typically would have account creation followed by usage contract signup and defining the behavior of the devices. Behavior here would be whether or not it is SMS enabled or voice enabled etc. A service profile defines device behavior. Service profiles are account specific, and all devices are provisioned using a service profile. A customer account may have many service profiles (for example, one service profile for SMS enabled and one more profile for both SMS and voice enabled) but only one service profile may be used per device. During creation, a service profile can be associated with one or multiple APNs via step 403. Therefore, an IP address block is always assigned for each combination of service profile with its associated APNs. As part of storing the service profile meta data, “IP address block” size may also be stored. The IP address block size is a measure of the number of sequential IP addresses that can be allocated to the service profile in a single operation. Service profiles can have different numbers of devices assigned to them; using these variable block sizes, block assignments may be created. These variable assignments optimize IP address allocation. For example, an account expecting 1024 devices using a service profile 1 410₁, might want to use a block size of 1024. This way a single block of 1024 sequential IP addresses can be allocated to the service profile. The above is more efficient than setting a block size of, for example, 16, because provisioning 1,024 devices with a block size of 16 would cause 64 blocks to be created for a single service profile. While IPs in each block are contiguous, the blocks might not be. Defining a service profile will not trigger creation/allocation of IP address blocks for that service profile. Instead, the first request to acquire an IP for a device using the service profile, will trigger the IP address allocation. This is to ensure that the allocated IP blocks are actually “in use.”

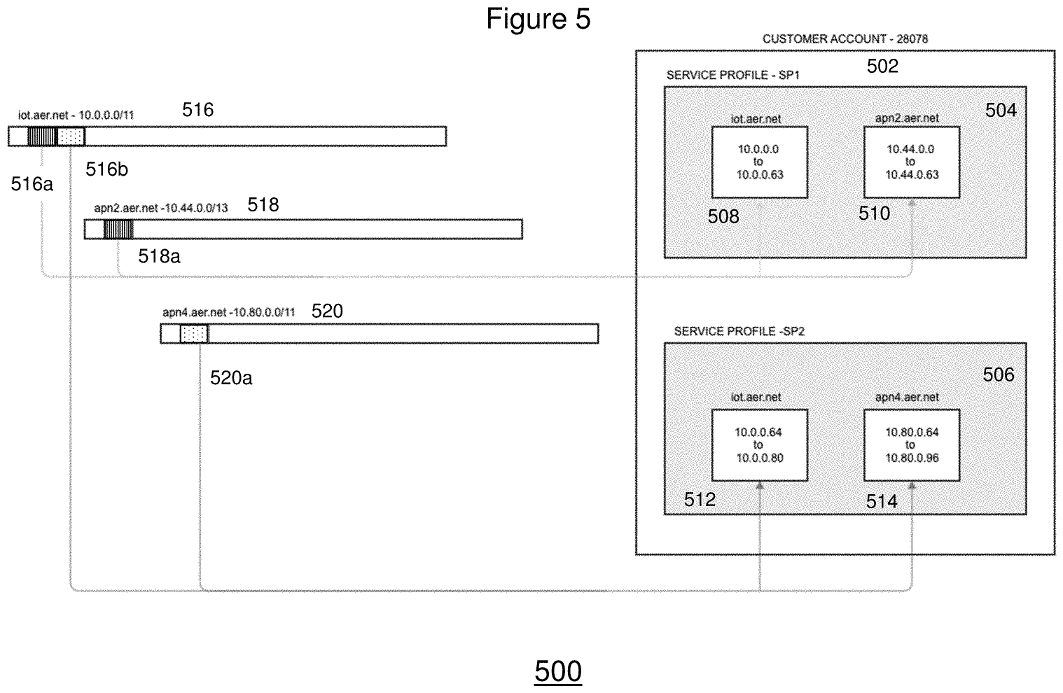

Acquiring IP includes IP address block allocation for service profile which is illustrated in FIG. 5 and is described in detail in the description accompanying FIG. 5, and device-IP address association as illustrated by step 406. When a device is provisioned by DPS 412, an ICCID of the device is associated with usage contract and service profile. One of the steps in device provisioning is to acquire an IP address via step 422. At this point, the service profile of the device is known. From the service profile, associated APNs are retrieved via step 414. For given Service profile+APN Combination, request to acquire an IP address for the device is triggered. If the service profile has for example, two APNs associated with, the device will be given two IP addresses, one per APN. (Use case: different billing per APN or choice between static vs dynamic.) Whether the IP address is static or dynamic is dependent on the characteristic of the APN.

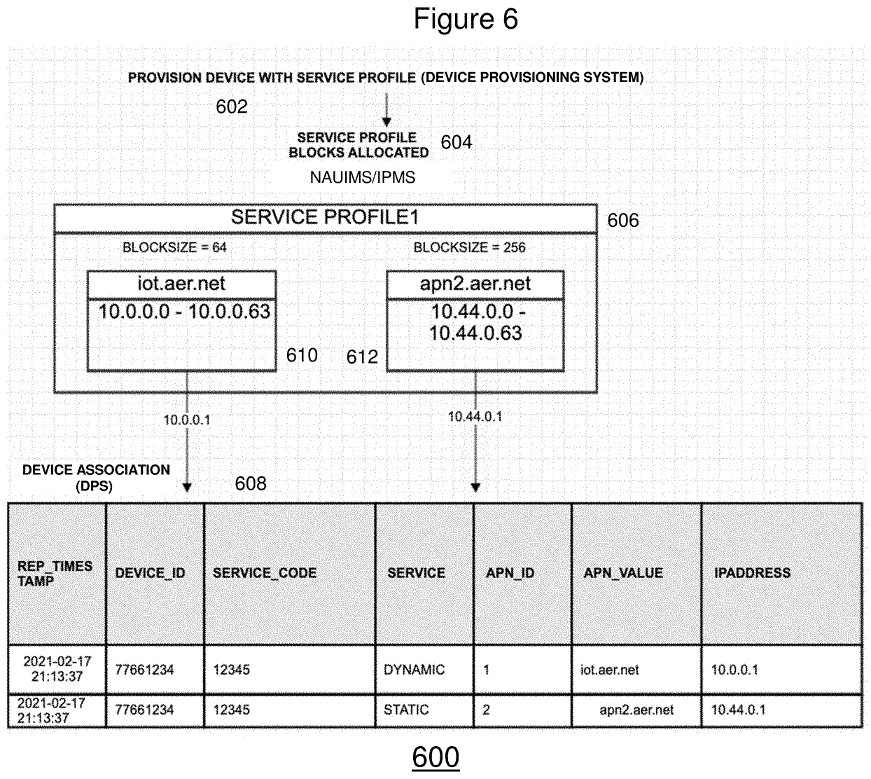

When acquire IP request comes in with a Service Profile (SP1) and APN (APN1), in an embodiment, the first preference for retrieving an IP address is to see if there exists any IP address that was “released” and that are associated with same SP1 and APN1 and satisfy the TTL conditions via step 424. If such an IP address is found, then that is acquired for the device via step 428. This ensures “reusability,” mitigating the possibility that all IP blocks for an APN are allocated. The second preference may be to see if there are any existing IP address blocks allocated to the SP1+APN1 already via step 426. If it finds that block is allocated and not exhausted, then an IP address is acquired from this block via step 428. When the IP address block(s) allocated to the service profile are exhausted, the system may trigger a new IP address block allocation after which an IP address is acquired. Each service profile block also holds a counter (like the APN range) via step 430. After the IP address is acquired, the device to IP address association is recorded via step 418. The above IP address associated with the device is the source IP address for mobile originated traffic, and the destination IP address for mobile terminated traffic. (A packet has a source IP address and a destination IP address.) Since the traffic control function, for example, APF, is already informed of the IP address block allocation via step 420, it determines what the network segment or subnet the IP Address falls into and uses the network segments or subnets to enforce the APF traffic rules/policies. The type of policy enforced is dependent on the service profile, because APF traffic rules and policies are defined at service profile creation. An example provisioning of device with service profile is illustrated in FIG. 6.

FIG. 5 illustrates an exemplary overview of system 500 and process used for defining and enforcing traffic policy for one or more devices enabled for connectivity over cellular or wireless network in accordance with an embodiment of the present invention. In an embodiment, as discussed above, a customer account can have many service profiles (for example, one service profile for SMS enabled and one more profile for both SMS and voice enabled) but only one service profile may be used per device. During creation, a service profile can be associated with one or multiple APNs. Therefore, an IP block is always assigned for each combination of service profile with its associated APNs. As part of storing the service profile meta data, “IP block” size may also be stored. The IP address block size is a measure of the number of sequential IP addresses that can be allocated to the service profile in a single operation. Service profiles can have different numbers of devices assigned to them; using these variable block sizes, block assignments may be created. These variable assignments optimize IP address allocation. These variable assignments optimize IP allocation. An account expecting 1024 devices using a service profile 1 502, might want to use a block size of 1024. This way a single block of 1024 sequential IP addresses can be allocated to the service profile. The above is more efficient than setting a block size of, for example, 16, because provisioning 1,024 devices with a block size of 16 would cause 64 blocks to be created for a single service profile. While IPs in each block are contiguous, the blocks might not be. Defining a service profile will not trigger creation/allocation of IP blocks for that service profile. Instead, the first request to acquire an IP for a device using the service profile, will trigger the IP allocation. This is to ensure that the allocated IP blocks are actually “in use.”

To ensure that IP blocks are created ONLY if the service profile has an associated device, the trigger for IP Block allocation is a request to acquire IP during device provisioning. IP Block Allocation request for example, for a customer account 502, for a service profile (SP1) 504 and APN (APN1) 508, first fetches the IP Range 516a for APN1 508 and checks if the requested number of IP addresses (which is block size from service profile meta data) are available or not. If available, a block of IP addresses from the APN1 508 will be allocated for SP1+APN1. If not available, it will get the next available network segment or subnet (IP Range) for the APN to see if block of IP addresses can be assigned. This will continue until a) the number of IP addresses=block size requested are fetched OR b) IP Range for the APN is exhausted. Depending on the IP range defined for the APN, the IP block allocation for the service profile might or might not be contiguous. Every time an IP Block is fetched from an APN to allocate to service profile, the counter of the APN IP range record is updated to point to next IP from where subsequent allocation should start. Once the IP Blocks are allocated, APF is notified about the newly created IP blocks created for the service profile (SP1) and APN (APN1). This is how APF knows which rules (APF Traffic rules=block/unblock traffic) to apply to which set of IPs (and what service profile is implied for this set of IP addresses).

FIG. 6 illustrates an exemplary overview of system 600 and process for provisioning a device with a service profile used for defining and enforcing traffic policy for one or more devices enabled for connectivity over cellular or wireless network in accordance with an embodiment of the present invention. For example, as illustrated in FIG. 6 a device is provisioned with a service profile via step 602, blocks of IP addresses, 606 are assigned to the service profile via step 604. The device to IP address association is illustrated by table 608.

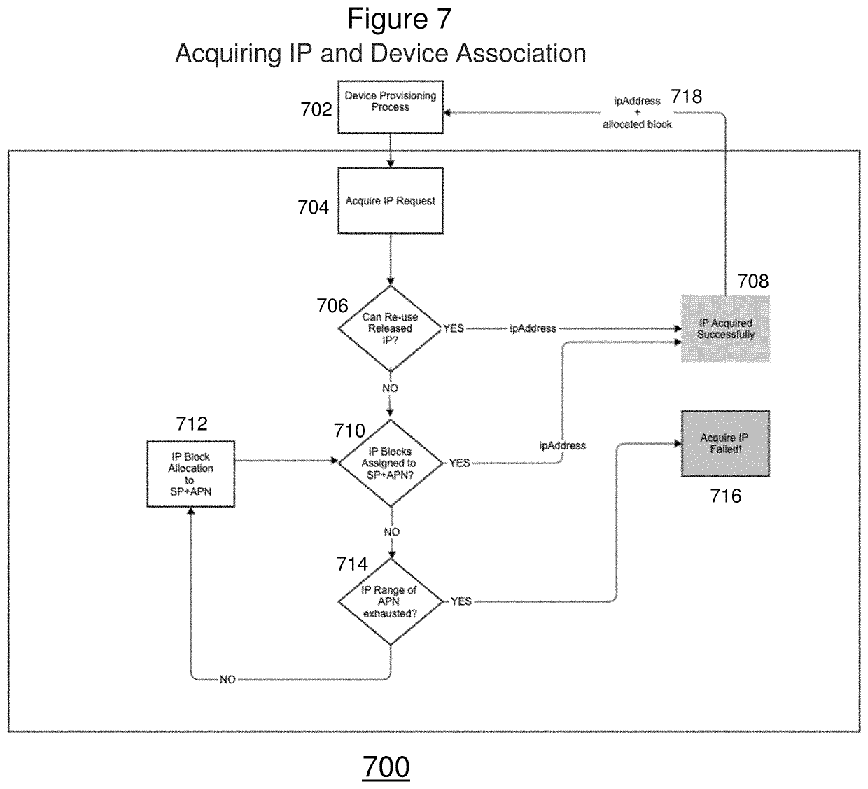

FIG. 7 illustrates an exemplary overview of system 700 and process for acquiring IP address and IP address-device association used for defining and enforcing traffic policy for one or more devices enabled for connectivity over cellular or wireless network in accordance with an embodiment of the present invention. For example, in an embodiment, to ensure that IP blocks are created ONLY if the service profile has an associated device, the trigger for IP Block allocation is a request to acquire IP during device provisioning.

One of the steps in device provisioning process 702 is to acquire an IP. At this point, the service profile of the device is known. From the service profile, associated APNs are retrieved. For given Service profile+APN Combination, a request to acquire an IP for the device is triggered via step 704. If service profile has 2 APNs associated with, the device will be given two IPs, one per APN. (Use case: different billing per APN or choice between static vs dynamic.) Whether the IP is static or dynamic is dependent on the characteristic of the APN. When the acquire IP request comes in with a service profile (SP1) and APN (APN1): a) The first choice for retrieving an IP is to see if there exists any IP that was “released” and that are associated with same SP1 and APN1 and satisfy the TTL conditions via step 706. If such an IP is found, then that is acquired for the device via step 708. b) The second choice is to see if there are any existing IP blocks allocated to the SP1+APN1 already via step 710. If it finds that block is allocated and not exhausted, then IP is acquired from this block via step 708. c) The third choice is to check if the IP block(s) allocated to service profile are exhausted via step 714. If it is, in such case, it triggers a new IP Block allocation via step 712 after which an IP is acquired via step 708. d) After the IP is acquired, the device to IP association is recorded via step 718.

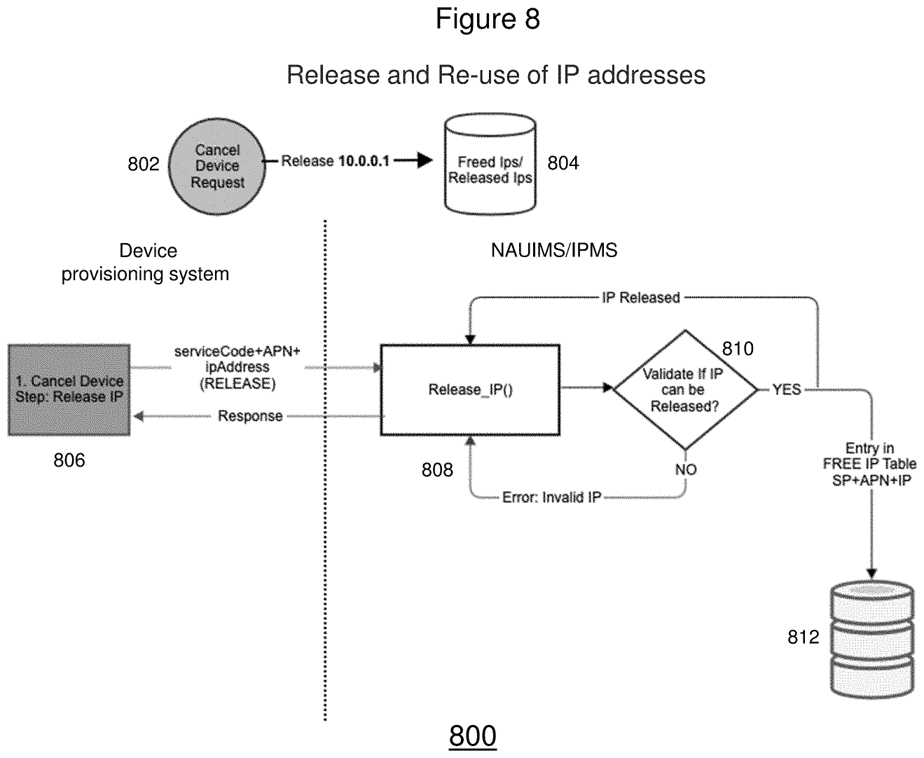

FIG. 8 illustrates an exemplary overview of system 800 and process for release and re-use of IP addresses used for defining and enforcing traffic policy for one or more devices enabled for connectivity over cellular or wireless network in accordance with an embodiment of the present invention. For example, some IP addresses that are used by the devices may no longer be in use as the devices are decommissioned, for example, for being faulty or dead via step 802. Those addresses are returned via step 804 to the MVNO or the carrier orchestrating the traffic control function (TCF), for example, APF, which after a certain period of time (TTL) may be acquired/re-assigned to devices again. However, this may lead to fragmentation of IP space. Over time as devices are cancelled via step 802, IP blocks may have ‘holes’ in the ranges. A couple of strategies to overcome this may be to re-use the released IP addresses via step 808 or create blocks of released IP addresses by harvesting them via step 810 and store the freed IP along with service profile and APN information via step 812 in a database.

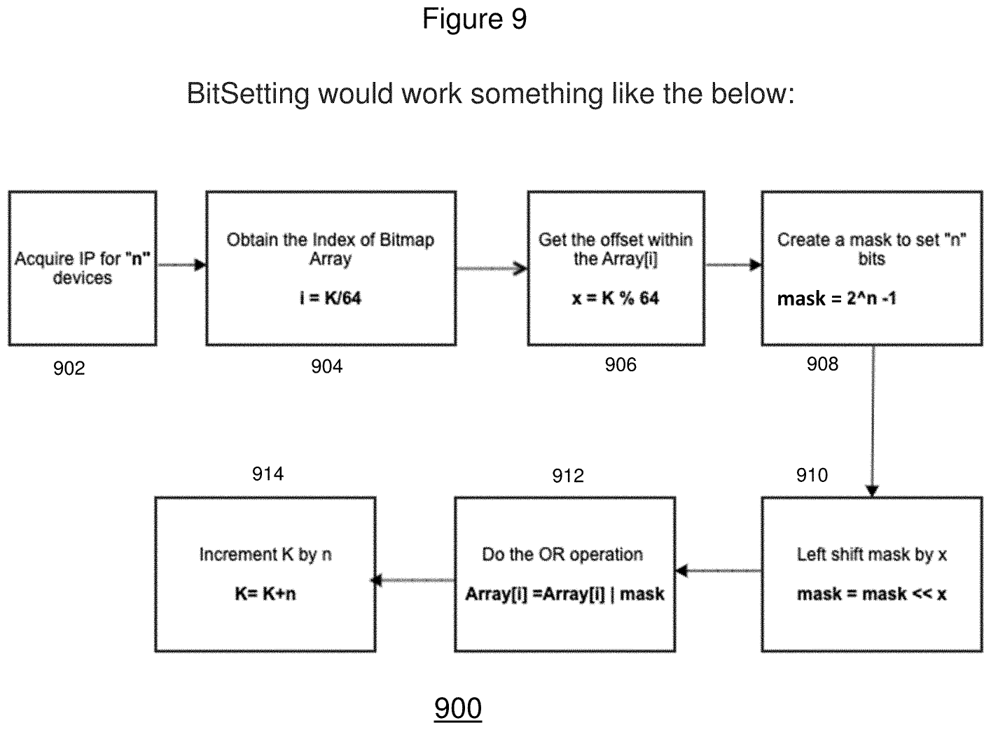

FIG. 9 illustrates an exemplary overview of system 900 and process used for defining and enforcing traffic policy for one or more devices enabled for connectivity over cellular or wireless network in accordance with an embodiment of the present invention. For example, FIG. 9 illustrates an optional method to keep track of which IP addresses in an APN are in use or free using bitmap via step 902 to 914. Although array representation is used here to explain the algorithm, it can be stored using any representation other than BIGINT array too. The bitmap is assumed to a BIGINT[ ] of size 16 to explain the concept.

For example, a request to assign IP addresses to n, for example, 3, devices is received via step 902. The system gets 3 IPs from the service_ip_blocks table and we will need to set 3 bits to mark them assigned/in-use via step 904. For setting these 3 bits, the system may: A) create a mask. To set “n” bits, we need a mask of 2n−1. So to set 3 bits, mask=23-1 (which is 7=111. These 1s represent the 3 IPs that have been assigned). B) Create offset key k via step 906. Initial value of k=0. C) Left shift mask by k: mask=mask«k=111«0=111 D) Perform OR Operation of A[0] with Mask: A[0]=A[0]∥mask.→This gives A[0]=7 (or 111) via step 912. E) Increment offset key identifier k=k+n=0+3=3 via step 914.

Next request to assign IP addresses to 3 more devices is received: A) create a mask: mask=23-1 via step 908. B) k=3 (from previous step). C) left shift mask by k: mask=mask«k=111«3=111000 via step 910. D) Perform OR operation with mask: A[0]=A[0]∥mask=000111|111000=111111 (so by this step, we set 6 bits in total for 3 IPs in the previous request+3 IPs in current request). E) Increment offset key by n: k=k+n=3+3=6. Assuming that the system continue so on until 147 IP addresses are assigned and reaches a point where offset key k=147.

Next request to assign IP addresses to 30 devices is received, therefore n=30. As mentioned above, each array element is of size 64 bits. The offset k=147 tells that 147 IP addresses are already assigned, which means all 64 bits in A[0] have already been set. So one additional step to add here is to get to the correct index of the BigInt Array and within that A[correct index] the system has to get the offset Kx. Therefore, for setting n=30 bits with offset key K=147, following steps are performed: A) Calculate Index of BitMap Array: index=K/64=147/64=2 (division by 64 can be done by right shift by 6 bits as well). Therefore, set bits in A[2] element. B) Calculate the offset Kx in A[2]: Kx=K % 64=19. C) Create a mask to set n=30 bits: mask=230-1. D) Left shift mask by Kx: mask=mask«k=230-1«19. E) Perform OR operation with mask: A[2]=A[2]|mask=A[2]|230-1«19. F). Increment offset by n: k=k+n=147+30=177.

To find whether the IP address is free or in use: an IP (in unsigned integer value) is evaluated to figure out which block it belongs to. For example, if the block start=167772160 and in this block, 167772160, 167772161, 167772162 and 167772163 have been assigned to devices already. To find the status of IP=167772163 subtract the Block Start from the given IP (in integer value), i.e., (167772163−167772160=3). This gives the offset key K. Therefore, for K=3, applying the above algorithm: Index of Bitmap array=index=K/64=3/64=0. Calculate the offset Kx in A[0]=K % 64=3 % 64=3. So the value of IP is the value to what the bit is set in A[0] and offset 3.

To reset the status of IP to FREE during Release IP Flow, the process described above is followed and the bit value is reversed. To make sure that the IP addresses are assigned from a lot that were previously assigned and freed up, instead of getting a new IP for every acquire IP call, for every given K, leaving boundary conditions (BlockSize−K) IP addresses are always FREE and available. If a request to acquire IP addresses for “m” devices is received, as a preprocessing step, the system may check for contiguous bits of “m” Zeroes in the 64 bits. If that result doesn't show any such slots, then the “m” IP addresses may be assigned from (BlockSize−K) lot.

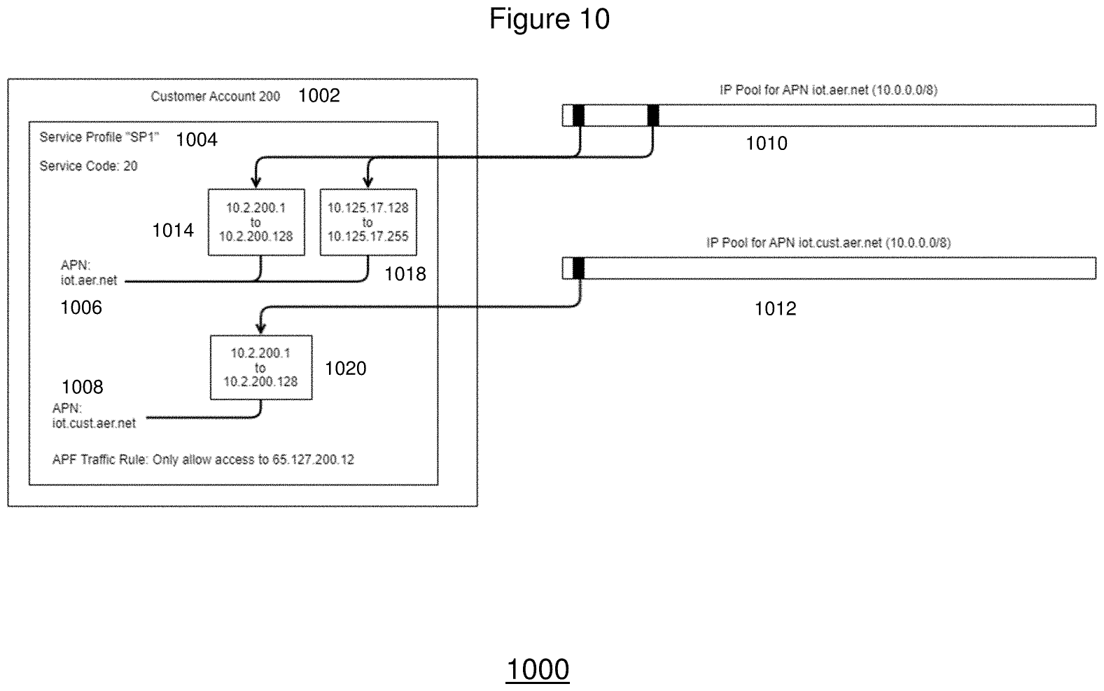

FIG. 10 illustrates an exemplary overview of system 1000 and process used for defining and enforcing traffic policy for one or more devices enabled for connectivity over cellular or wireless network in accordance with an embodiment of the present invention. A service profile defines device behavior. Service profiles are account specific, and all devices are provisioned using a service profile. A customer account 1002 can have many service profiles but only one service profile, for example, 1004 per device. IP address blocks, for example, 1014, 1018 etc. are picked from a range or pool of IP addresses specific for a service profile 1010 and are assigned to APN 1006. Similarly, IP address block, for example, 1020 is picked from a range or pool of IP addresses specific for a service profile 1012 and are assigned to APN 1008.

Example of a company defining 3 levels of service profiles. Example of tier 1: bigger pipe, lower latency, full access anywhere. Example of tier 3/low end service: low bandwidth, long latency, access to a small set of backend servers. Define and reserve a block of IP ranges for each service profile. They cannot overlap.

As described above, a service profile can specify multiple APNs. Network segments or subnets allow grouping of devices into smaller sets of Policy and Charging Control (FCC) rules. 1 million devices with 1 million PCC rules, or 1 million devices with 1 thousand PCC rules depending on the size of the service profile. To reduce the number of rules in the APF, network segments or subnets may be used instead of single IPs. APF traffic policy rules may be defined per service profile, hence IP network segments or subnets (blocks) may be assigned to service profiles for each APN. All devices for a given APN, in assigned network segment(s) or subnet(s) may have the traffic policy defined by the service profile applied. Thus, in an embodiment, the traffic policy rules may be defined as a set of rules for individual subscriptions or one or more groups of subscriptions that define device behavior.

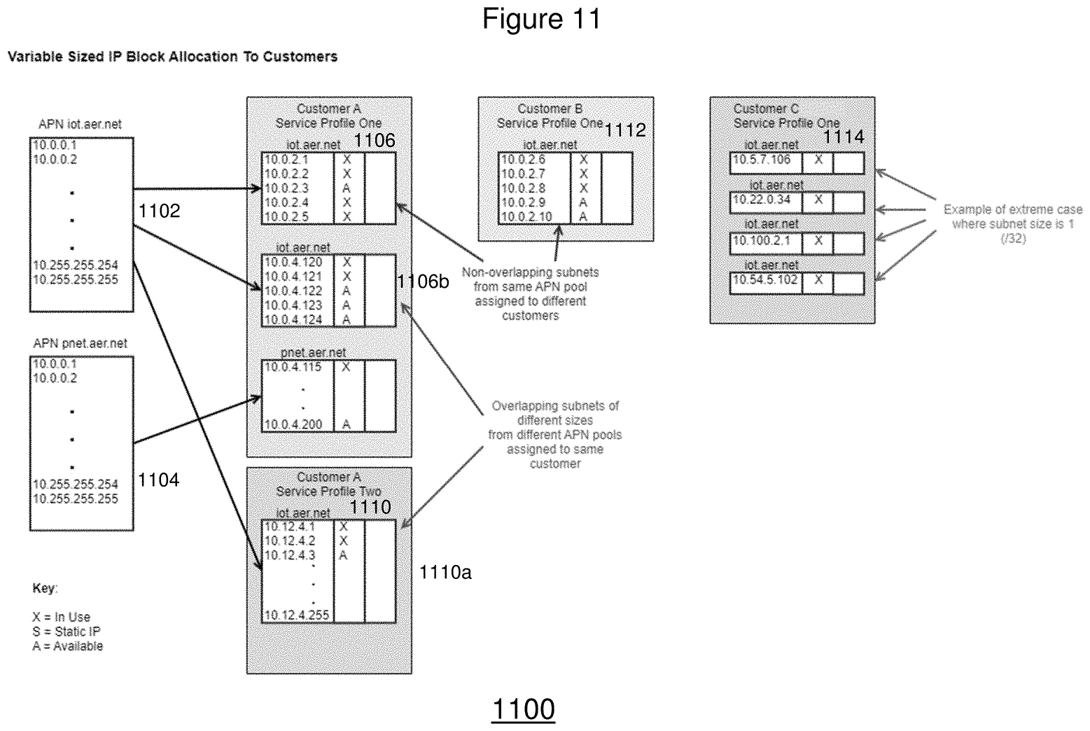

FIG. 11 illustrates an exemplary overview of system 1100 and process for variable sized IP block allocation used for defining and enforcing traffic policy for one or more devices enabled for connectivity over cellular or wireless network in accordance with an embodiment of the present invention. For example, a manufacturer may want to provision a large group of devices at the same time. In mapping the IMSIs to the IP block, variable block sizes may be used to create the block assignments, for example, blocks 1102, 1104 etc. for APNs. These variable assignments optimize the IP allocation, for example customer A, service profile 1 may receive some IP addresses from block 1102 and some from block 1104 depending on APNs for different subnets. Blocks are used to optimize the routing. In an embodiment, non-overlapping subnets from same APN pool may be assigned to different customers, for example, customer A 1106 and customer C 1112, whereas non-overlapping subnets of different sizes from different APN pools may be assigned to the same customer, for example, 1106b and 1110a are assigned from block 1102. Down the road, as IP addresses are no longer being used by devices, those addresses are returned to the MVNO or the carrier that provides the traffic control function, for example, APF, where they can be pooled for re-use or the blocks that they came from may be compressed.

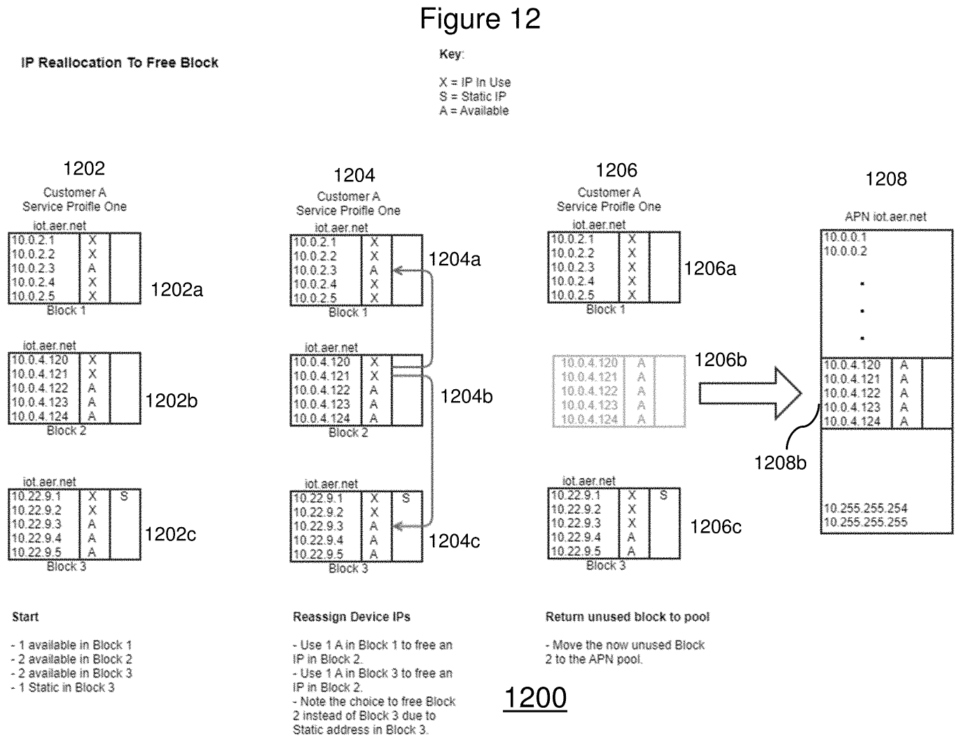

FIG. 12 illustrates an exemplary overview of system 1200 and process for IP reallocation to free block used for defining and enforcing traffic policy for one or more devices enabled for connectivity over cellular or wireless network in accordance with an embodiment of the present invention. Although devices always have an IP association, dynamic IP addresses can change, allowing the use of IP blocks more efficiently. As illustrated in FIG. 12, step 1202 shows customer A with service profile One has three blocks 1202a, 1202b and 1202c allocated. The device Ips may be reassigned as illustrated by step 1204. Step 1206 illustrates returning unused block of IPs, for example, block 1206b to the APN pool illustrated by 1208 as 1208b.

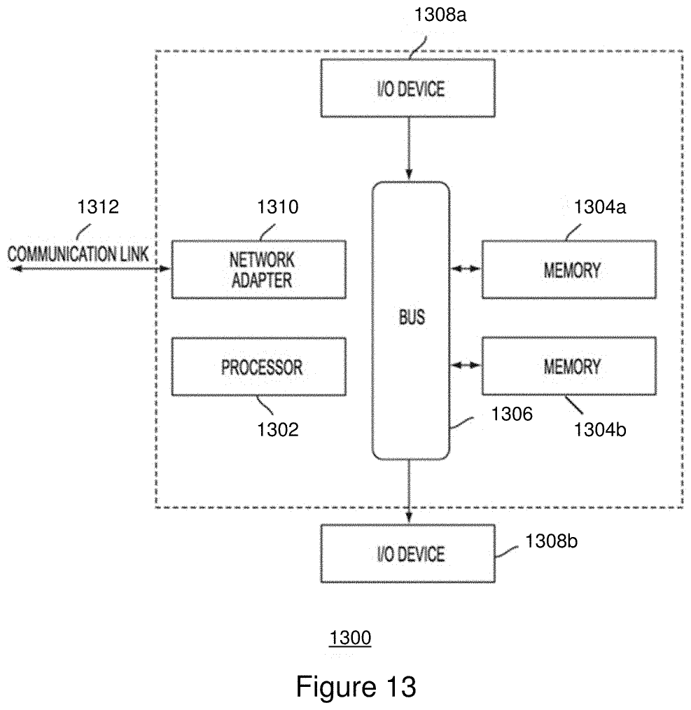

FIG. 13 illustrates a data processing system 1300 suitable for storing the computer program product and/or executing program code in accordance with an embodiment of the present invention. The data processing system 1300 includes a processor 1302 coupled to memory elements 1304a-b through a system bus 1306. In an embodiment, the data processing system 1300 may include more than one processor and each processor may be coupled directly or indirectly to one or more memory elements through a system bus.

Memory elements 1304a-b can include local memory employed during actual execution of the program code, bulk storage, and cache memories that provide temporary storage of at least some program code in order to reduce the number of times the code must be retrieved from bulk storage during execution. As shown, input/output or I/O devices 1308a-b (including, but not limited to, keyboards, displays, pointing devices, etc.) are coupled to the data processing system 1300. I/O devices 1308a-b may be coupled to the data processing system 1300 directly or indirectly through intervening I/O controllers (not shown).

In FIG. 13, a network adapter 1310 is coupled to the data processing system 702 to enable data processing system 1302 to become coupled to other data processing systems or remote printers or storage devices through communication link 1312. Communication link 1312 can be a private or public network. Modems, cable modems, and Ethernet cards are just a few of the currently available types of network adapters.

Embodiments described herein can take the form of an entirely hardware implementation, an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include digital versatile disk (DVD), compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, terminal, remote device, wireless asset, etc. are intended to be inclusive, interchangeable, and/or synonymous with one another and other similar communication-based equipment for purposes of the present invention though one will recognize that functionally each may have unique characteristics, functions and/or operations which may be specific to its individual capabilities and/or deployment.

Similarly, it is envisioned by the present invention that the term communications network includes communications across a network (such as that of a M2M but not limited thereto) using one or more communication architectures, methods, and networks, including but not limited to: Code Division Multiple Access (CDMA), Global System for Mobile Communications (GSM) (“GSM” is a trademark of the GSM Association), Universal Mobile Telecommunications System (UMTS), Long Term Evolution (LTE), fourth generation cellular systems (4G) LTE, 5G, wireless local area network (WLAN), and one or more wired networks.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer-implemented method for defining and enforcing network traffic policy for one or more devices enabled for connectivity over a communications network:
defining traffic policy rules for a service profile, wherein the service profile is service behavior definition based on communications network subscription;
assigning a range of network assigned unique identifiers to the service profile;
associating at least one device with at least one of the range of network assigned unique identifiers assigned to the service profile using communication network subscription identifier; and
enforcing the defined traffic policy rules on the network traffic to and from the at least one device based on the network assigned unique identifier associated to the said at least one device.

2. The method of claim 1, wherein the communications network comprises a cellular network, communications network subscription comprises a cellular subscription and communication network subscription identifier comprises any of International Mobile Subscriber Identity (IMSI), MAC identifier and International Mobile Equipment Identity (IMEI) for the at least one device.

3. The method of claim 1, wherein the traffic policy rules are defined as a set of rules for individual subscriptions or one or more groups of subscriptions that define device behavior.

4. The method of claim 1, wherein the network assigned unique identifier comprises an internet protocol (IP) address and wherein the IP address is a static IP address or a dynamic IP address.

5. The method of claim 4, wherein the range of internet protocol (IP) addresses may be contiguous or non-contiguous.

6. The method of claim 1, further comprising: assigning a range of internet protocol (IP) addresses to one or more access point names (APNs).

7. The method of claim 6, further comprising: assigning the one or more access point names (APNs) to one or more service profiles.

8. The method of claim 1, wherein defining policy rules for the service profile includes any one or more of: allowing one or more destination IP addresses for a source IP address, denying one or more destination IP addresses for a source IP address, logging traffic to and from the source IP address, redirecting traffic to one or more different destination IP addresses for a source IP address, allowing access to a defined set of IP addresses for a source IP address, forbidding traffic from one customer's devices from reaching another customer's devices, quality of service (QoS), delay control, throttle, prioritizing of traffic based on protocol, prioritizing of traffic based on destination and application specific packet rewrite.

9. The method of claim 1, wherein the policy rules defined for a service profile are specific to a region, a network or a combination thereof.

10. The method of claim 8, wherein at least one of the source IP address and the destination IP address comprises an IP address associated with the at least one device.

11. A system for defining and enforcing traffic policy one or more devices enabled for connectivity over a communications network comprises one or more devices enabled for connectivity, a network assigned unique identifier management service (NAUIMS), a traffic control function (TCF) and a device provisioning service (DPS),
wherein the device provisioning service (DPS) associates one or more devices to a service profile, and defines traffic policy rules for the service profile;
the network assigned unique identifier management service (NAUIMS) assigns a range of network assigned unique identifiers to the service profile; and
associates at least one device with one of the range of network assigned unique identifiers assigned to the service profile using communication network subscription identifier for the at least one device; and
wherein the traffic control function (TCF) enforces the defined traffic policy rules on the network traffic to and from the at least one device based on the network assigned unique identifier assigned to the said at least one device.

12. The system of claim 11, wherein the communications network comprises a cellular network, communications network subscription comprises a cellular subscription and communication network subscription identifier comprises any of International Mobile Subscriber Identity (IMSI), MAC identifier and International Mobile Equipment Identity (IMEI) for the at least one device.

13. The system of claim 11, wherein the traffic policy rules are defined as a set of rules for individual subscriptions or one or more groups of subscriptions that define device behavior.

14. The system of claim 11, wherein the network assigned unique identifier comprises an IP address and wherein the IP address is a static IP address or a dynamic IP address.

15. The system of claim 14, wherein the range of IP addresses may be contiguous or non-contiguous.

16. The system of claim 14, further comprising: assigning a range of internet protocol (IP) addresses to one or more access point names (APNs).

17. The system of claim 16, further comprising: assigning the one or more access point names (APNs) to one or more service profiles.

18. The system of claim 11, wherein defining policy rules for the service profile includes any one or more of: allowing one or more destination IP addresses for a source IP address, denying one or more destination IP addresses for a source IP address, logging traffic to and from the source IP address, redirecting traffic to one or more different destination IP addresses for a source IP address, allowing access to a defined set of IP addresses for a source IP address, forbidding traffic from one customer's devices from reaching another customer's devices, quality of service (QoS), delay control, throttle, prioritizing of traffic based on protocol, prioritizing of traffic based on destination and application specific packet rewrite.

19. The system of claim 11, wherein the policy rules defined for a service profile are specific to a region, a network or a combination thereof.

20. The system of claim 19, wherein at least one of the source IP address and the destination IP address comprises an IP address associated with the at least one device.

21. A computer program product stored on a non-transitory computer readable medium for defining and enforcing traffic policy for one or more devices enabled for connectivity over a communications network, comprising computer readable instructions for causing a computer to control an execution of an application for defining and enforcing traffic policy for one or more devices enabled for connectivity comprising:
defining traffic policy rules for a service profile, wherein the service profile is service behavior definition based on communications network subscription;
assigning a range of network assigned unique identifiers to the service profile;
associating at least one device with at least one of the range of network assigned unique identifiers assigned to the service profile using communication network subscription identifier; and
enforcing the defined traffic policy rules on the network traffic to and from the at least one device based on the network assigned unique identifier associated to the said at least one device.

22. The computer program product of claim 21, wherein the communications network comprises a cellular network, communications network subscription comprises a cellular subscription and communication network subscription identifier comprises any of International Mobile Subscriber Identity (IMSI), MAC identifier and International Mobile Equipment Identity (IMEI) for the at least one device.

23. The computer program product of claim 21, wherein the traffic policy rules are defined as a set of rules for individual subscriptions or one or more groups of subscriptions that define device behavior.

24. The computer program product of claim 21, wherein the network assigned unique identifier comprises an IP address and wherein the IP address is a static IP address or a dynamic IP address.

25. The computer program product of claim 24, wherein the range of IP addresses may be contiguous or non-contiguous.

26. The computer program product of claim 24, further comprising: assigning a range of internet protocol (IP) addresses to one or more access point names (APNs).

27. The computer program product of claim 26, further comprising: assigning the one or more access point names (APNs) to one or more service profiles.

28. The computer program product of claim 21, wherein defining policy rules for the service profile includes any one or more of: allowing one or more destination IP addresses for a source IP address, denying one or more destination IP addresses for a source IP address, logging traffic to and from the source IP address, redirecting traffic to one or more different destination IP addresses for a source IP address, allowing access to a defined set of IP addresses for a source IP address, forbidding traffic from one customer's devices from reaching another customer's devices, quality of service (QoS), delay control, throttle, prioritizing of traffic based on protocol, prioritizing of traffic based on destination and application specific packet rewrite.

29. The computer program product of claim 21, wherein the policy rules defined for a service profile are specific to a region, a network or a combination thereof.

30. The system of claim 28, wherein at least one of the source IP address and the destination IP address comprises an IP address associated with the at least one device.
